(19) United States
(12) Patent Application Publication
(10) Pub. No.: US 2015/0156538 A1
(43) Pub. Date: Jun. 4, 2015

(54) Portable, multi-channel, multi-user, online streaming and recording and offline streaming and playback device

(71) Applicant: Vishwas Godbole, Saratoga, CA (US)

(72) Inventor: Vishwas Godbole, Saratoga, CA (US)

(21) Appl. No.: 14/557,442

(22) Filed: Dec. 1, 2014

Related U.S. Application Data
(60) Provisional application No. 61/910,428, filed on Dec. 2, 2013.

(51) Int. Cl. H04N 21/433; H04N 21/4627; H04N 21/647; H04N 21/4363; H04N 21/438; H04N 21/643; H04N 21/436

(52) U.S. Cl. CPC H04N 21/4334; H04N 21/64322; H04N 21/4627; H04N 21/43615; H04N 21/43632; H04N 21/43637; H04N 21/438; H04N 21/64707

(57) ABSTRACT

The current invention pertains to a device comprising a connection to the internet, a storage memory for storing one or more audiovisual contents downloaded from one or more service providers, wherein the one or more audiovisual contents are stored in a manner accessible only by the architecture of the device and wherein the device transmits the stored one or more audiovisual contents only to the one or more authorized audiovisual devices, and one or more connections for transmitting the one or more audiovisual contents to the one or more authorized audiovisual devices. The device of the current invention is capable of streaming and/or downloading one or more audiovisual contents and simultaneously transmitting the one or more audiovisual contents to the one or more authorized audiovisual devices as data packets over a local area network (LAN) or as uncompressed audiovisual signal over a multimedia interface.

### BACKGROUND

With the proliferation of broadband internet, online streaming of music, movies, TV shows and other video content has become popular and many subscription services are available. An example of a popular service is Netflix. Netflix offers two types of subscription plans. One plan provides online streaming. Another plan provides content on physical media such as DVD or Blu-ray™ through mail.

Shortcomings of Streaming

Online streaming is capable of providing an excellent high quality, for example, High Definition (HD), video experience when used with the highest possible consumer based broadband Internet Service Providers (ISPs). However, such services are not universally available beyond the major metropolitan markets. When only limited bandwidth is available, the encoded stream uses additional compression, lowering resolution and increasing the number of visual artifacts which results in a total lower overall quality experience.

In the mobile context, destination devices often have less total bandwidth available and operate under carrier imposed limits on total transfer amounts (e.g., 5 GB per month) with additional cost for usage exceeding the plan limit. Often streams sent to portable or mobile devices are tuned to the maximum resolution of the destination device and appear degraded when displayed on higher resolution devices, for example, when connected to a TV through an HDMI connection. Additionally, in the streaming model, each concurrent and subsequent viewing requires a separate stream for each instance of the stream which increases the amount of total bandwidth required and total data transferred.

Shortcomings of Physical Media

Physical media can provide higher quality video than often possible in the streaming context. For example, Blu-ray™ is now widely available which provides the current highest possible HD experience. But current mail based rental models (e.g., Netflix) allow a subscriber to receive physical media by mail from a distribution center and after viewing the subscriber is required to return the media by the same mechanism. The turn-around time for each physical media through mail is typically 2 days and often longer. Physical media can be compromised (e.g., scratched) by poor handling and have to be replaced. The number of customers that can be simultaneously supplied with physical media also depends upon the number of copies licensed by the service provider. Often times a customer's desired selection is not available. The physical media rental model is much less profitable for the service provider due to the cost of shipping and distribution as well as other factors discussed. Generally rental customers are less satisfied with wait times imposed by shipping and distribution and selection quantities available of physical media.

The current invention solves the problems with streaming and physical media based entertainment by providing a portable, multi channel, multi user online streaming and recording and offline streaming and playback device.

### SUMMARY OF THE INVENTION

The current invention provides a device comprising:
a. a connection to the internet,
b. a storage memory for storing one or more audiovisual contents downloaded from one or more service providers, wherein the one or more audiovisual contents are stored in a manner accessible only by the architecture of the device and wherein the device transmits the stored one or more audiovisual contents only to the one or more authorized audiovisual devices,
c. one or more connections for transmitting the one or more audiovisual contents to the one or more authorized audiovisual devices,

wherein, the device is capable of streaming and/or downloading the one or more audiovisual contents and transmitting the one or more audiovisual contents to the one or more authorized audiovisual devices as data packets over a local area network (LAN) or as uncompressed audiovisual signal over a multimedia interface.

A Digital Rights Management (DRM) firmware specific for one or more service providers manages the transmission of the one or more audiovisual contents to the one or more authorized audiovisual devices.

The device of the current invention is referred to hereinafter as “the Device.”

The Device overcomes the shortcomings of online streaming and physical media distributed by mail by combining the best features of the two formats.

The Device in an online mode can transmit one or more audiovisual contents streamed from one or more service providers to one or more authorized audiovisual devices. In a multichannel online mode, the device can stream a plurality of audiovisual contents from a plurality of service providers and transmit the plurality of audiovisual contents to a plurality of authorized audiovisual devices authorized by their respective service providers.

The Device can also download audiovisual contents received from one or more service providers in the internal memory of the Device. In an offline mode, the Device can transmit the downloaded audiovisual contents to one or more authorized audiovisual devices without again having to access the same audiovisual content from the one or more service providers. The Device can also download the audiovisual content for storage in the internal memory of the Device at a scheduled time, i.e. a time predetermined by the subscriber.

In a hybrid mode, the Device can stream certain one or more audiovisual contents from certain one or more service providers and transmit the certain one or more audiovisual contents to certain one or more authorized audiovisual devices and simultaneously transmit certain other one or more audiovisual contents downloaded by the Device from certain other one or more service providers to certain other one or more authorized audiovisual devices.

The Device can also transmit audiovisual content to a computer connected to it through the USB port, for example, when the subscriber is traveling on an airplane where wireless transmission between devices is not permitted.

Additionally, since the Device is portable, users can take the Device with them anywhere and view the stored audiovisual contents on any authorized audiovisual device, including but not limited to, a TV, a computer, a mobile phone, or a tablet.

The downloaded audiovisual contents or audiovisual contents streamed from the service providers can be routed, i.e. simultaneously and selectively transmitted, by the Device to a plurality of authorized audiovisual devices, for example, as data packets through the LAN and/or as uncompressed audiovisual signal through the multimedia interface. The feature allowing each member of a group to view their own selected content on their authorized audiovisual device is of major benefit and convenience of the Device.

Furthermore, disposal of viewed audiovisual content by the subscriber and receipt of new audiovisual content from the service provider is easier and faster compared to returning a DVD by mail since the Device is able to erase the viewed audiovisual content and store the new audiovisual content.

In the online mode, the Device can connect to service providers and download or stream audiovisual contents for different users and provide the audiovisual contents to the users via multimedia interface or local area network (LAN). In this mode, all devices can connect to the internet through their own Wi-Fi interfaces and an external wireless router connected to an ISP gateway. Alternatively the Device can directly connect to the internet through its Ethernet port connected through an external Ethernet router to an ISP gateway and the audiovisual devices can connect to the Device using the Device as the wireless access point. The Device is the only point which provides audiovisual contents to a subscriber thereby providing a strong protection to the service provider's audiovisual contents and the rights of the owner's of the audiovisual contents.

In the online hybrid mode, in addition to streaming audiovisual contents, the audiovisual contents stored by the Device are also transmitted to individual users.

In the offline mode, the Device transmits the audiovisual contents downloaded by the Device to authorized audiovisual devices. The Device provides major benefits to the subscribers by eliminating the need for restreaming of the same content, provides the content at the highest quality available and outside the subscriber's home, for example, while traveling

### BRIEF DESCRIPTION OF FIGURES

FIG. 1 shows the architecture of the Device.

FIG. 2 shows an example of operation of the Device in online mode for streaming to a TV or a computer and for downloading audiovisual content to storage.

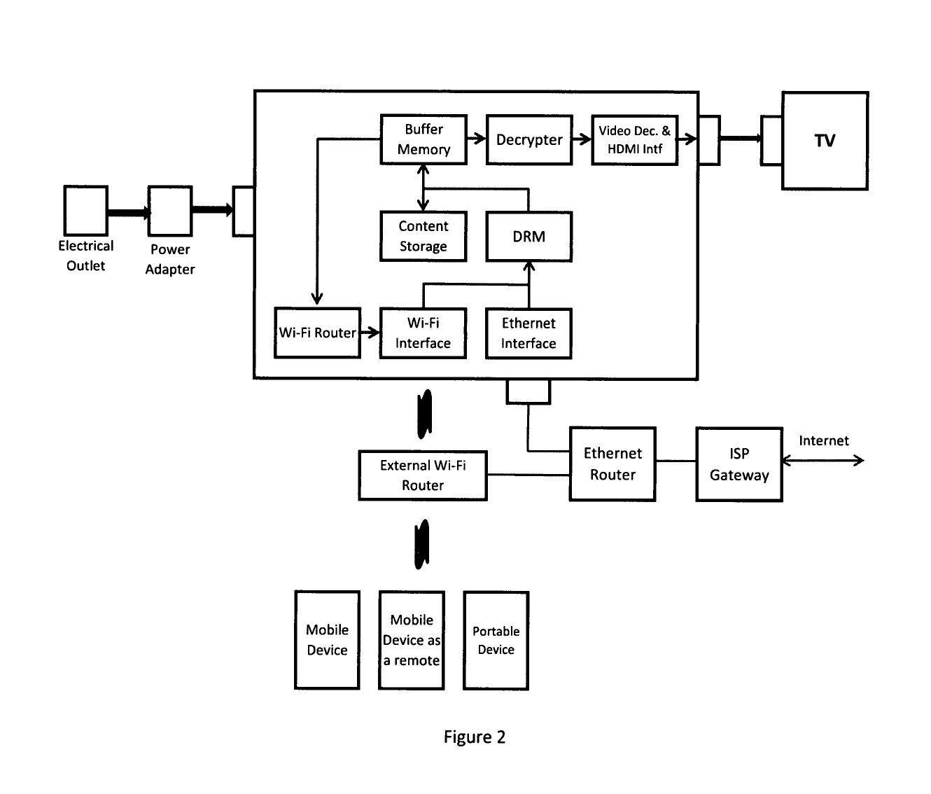

FIG. 3 shows an example of the Device working in the hybrid mode.

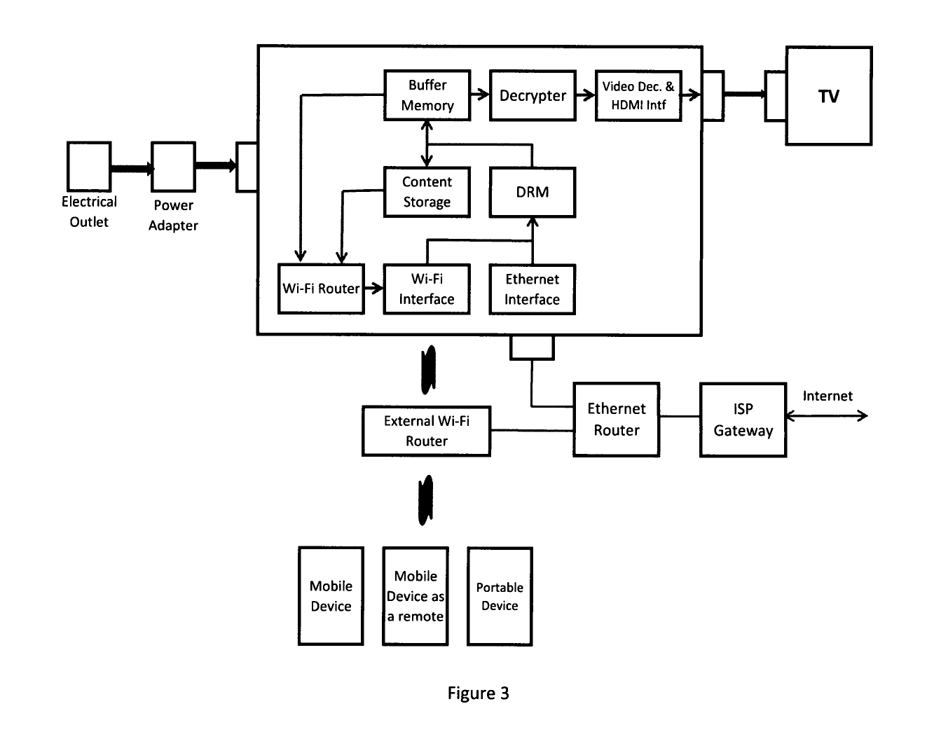

FIG. 4 shows an example of operation of the Device in offline mode powered by internal battery for simultaneous and selective streaming of stored content on multiple audiovisual devices.

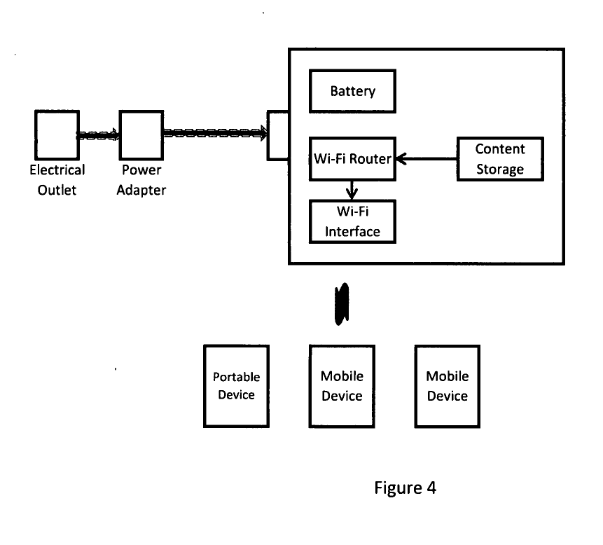

FIG. 5 shows an example of operation of the Device in the offline mode powered by an external power source for simultaneous and selective streaming and/or playback of stored content on multiple portable and mobile devices and to a connected TV.

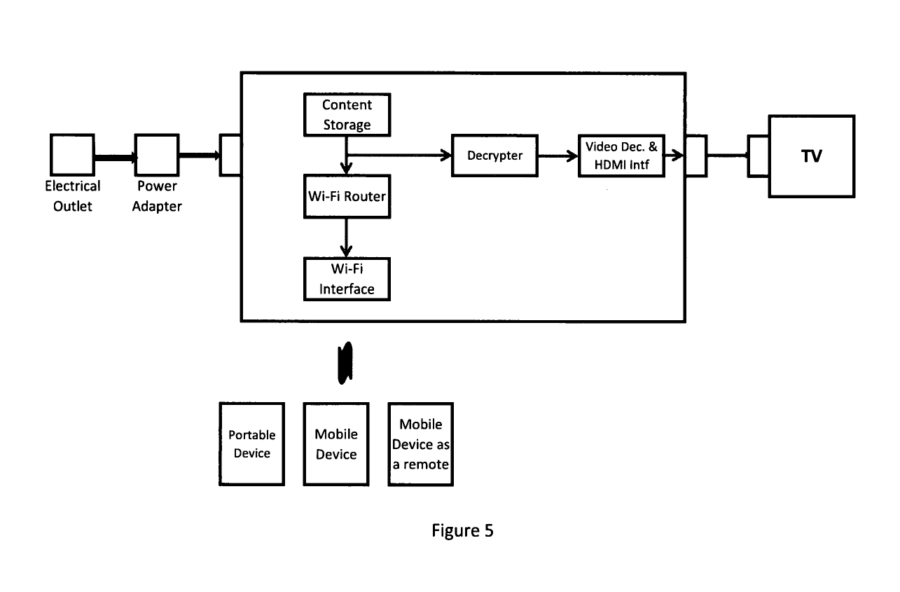

FIG. 6 shows an example of operation of the Device in the offline mode using a portable computer when the subscriber is on an airplane.

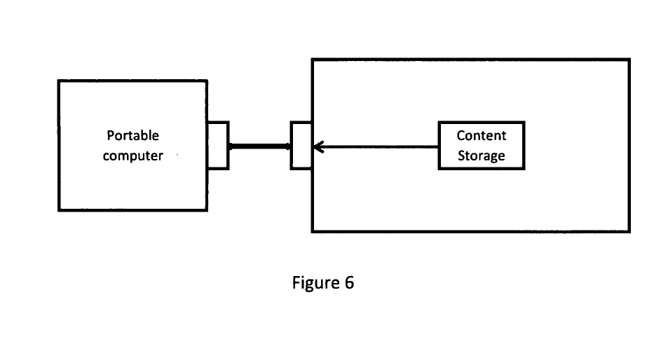

FIG. 7 shows an example of XLAN where a wireless local area network is formed between the Device and the audiovisual devices wherein an external Wi-Fi router serves as the wireless access point for the Device and the audiovisual devices and provides internet access through the ISP gateway for operation in online mode.

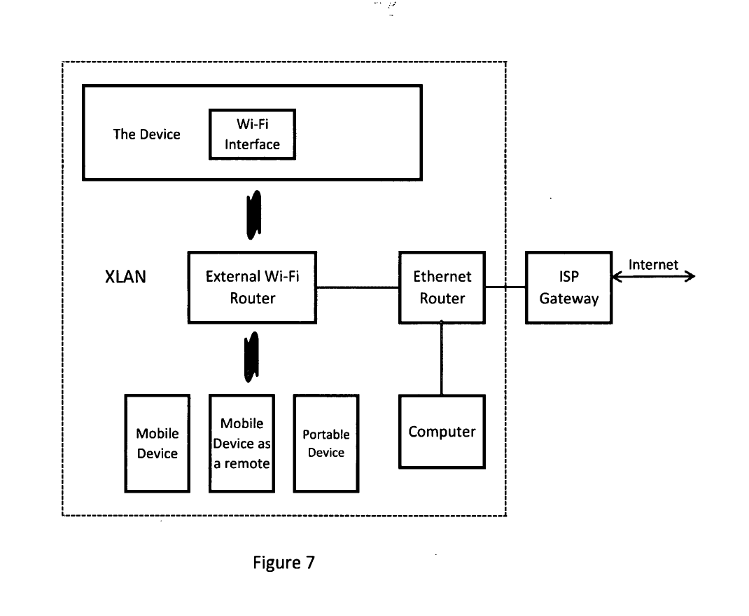

FIG. 8 shows an example of ILAN where a wireless local area network is formed between the Device and the audiovisual devices wherein the Device serves as the wireless access point for the audiovisual devices for operation in offline mode.

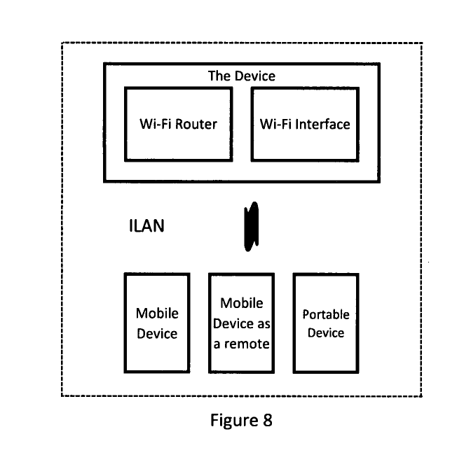

FIG. 9 shows an example of a mixed use of XLAN and ILAN for a mixed online and offline mode of operation. In this example, the Device through its Ethernet port and one or more of the audiovisual devices using the external Wi-Fi router as their wireless access point connect to the internet over the XLAN operating in online mode and one or more of the audiovisual devices connect to the Device using the Device as a wireless access point operating in offline mode.

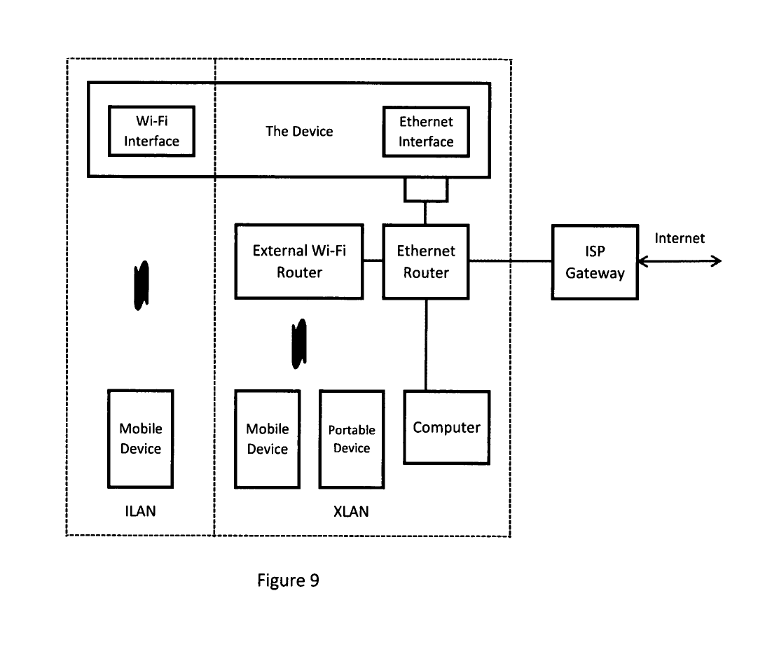

### DETAILED DESCRIPTION OF THE INVENTION

The current invention provides a device comprising:
a. a connection to the internet,
b. a storage memory for storing one or more audiovisual contents downloaded from one or more service providers, wherein the one or more audiovisual contents are stored in a manner accessible only by the architecture of the device and wherein the device transmits the stored one or more audiovisual contents only to the one or more authorized audiovisual devices,
c. one or more connections for transmitting the one or more audiovisual contents to the one or more authorized audiovisual devices,

wherein, the device is capable of streaming and/or downloading the one or more audiovisual contents and transmitting the one or more audiovisual contents to the one or more authorized audiovisual devices as data packets over a LAN or as uncompressed audiovisual signal over a multimedia interface.

A Digital Rights Management (DRM) firmware specific for one or more service providers manages the transmission of the one or more audiovisual contents to the one or more authorized audiovisual devices.

For the purpose of this invention an audiovisual device is a device capable of presenting audiovisual content. The audiovisual device can be a large device, for example, a TV or a desktop computer, or a portable audiovisual device, for example, a mobile phone or a tablet.

For the purpose of the current invention, an authorized audiovisual device refers to the audiovisual device that is identified by the Device to which transmission of the audiovisual content is permitted. In an embodiment of the invention, an audiovisual device can be identified by the Device as an authorized audiovisual device based on the audiovisual device's media access control (MAC) address. In another embodiment of the invention, an audiovisual device is identified by the Device as authorized audiovisual device based on the password provided by the user of the audiovisual device. Additional methods and embodiments of identifying an audiovisual device as an authorized audiovisual device are well known to a person of ordinary skill in the art and such methods and embodiments are within the purview of the current invention. Further, any audiovisual device physically connected to the Device through the multimedia interface supporting High-bandwidth Digital Content Protection (HDCP) is an authorized audiovisual device and the audiovisual contents can be transmitted by the Device to such device.

For the purpose of this invention, an audiovisual content refers to audiovisual data corresponding to a single audiovisual program. An example of an audiovisual content is audiovisual data corresponding to a movie. Additional non-limiting examples of audiovisual programs include a sport event, a drama, a song, and an episode of a TV serial. Additional examples of audiovisual programs are well known to a person of ordinary skill in the art and such embodiments are within the purview of the current invention.

The Device of the current invention can transmit an audiovisual content to an authorized audiovisual device through a LAN as data packets or through multimedia interface as uncompressed audiovisual signal. Accordingly, the terms “transmit,” “transmits,” “transmitting” as used in the current invention refer to transfer of an audiovisual content from the device to an authorized audiovisual device as uncompressed audiovisual signal through multimedia interface or as data packets through the LAN.

Also, the terms “transmit,” “transmits,” “transmitting” as used in the current invention as they apply to transfer of one or more audiovisual contents to a plurality of audiovisual devices refer to transmission of the one or more audiovisual contents as uncompressed audiovisual signal through multimedia interface and/or as data packets through the LAN. For example, the Device can transmit an audiovisual content to simultaneously to five authorized audiovisual devices, four through the LAN as data packets and one through the multimedia interface as uncompressed audiovisual signal.

In an embodiment of the invention, the connection to the internet is through a wireless connection through Wi-Fi. Wi-Fi is a technology that allows an electronic device to exchange data or connect to the internet wirelessly. In the online mode, the Wi-Fi interface connects the Device to internet through an external Wi-Fi router to the ISP gateway or through the Device's Wi-Fi router.

Wi-Fi Interface: The Device incorporates a wireless network interface controller (WNIC) that transmits and receives radio frequencies for wireless enabled devices to communicate with the Device. The Wi-Fi interface supports the widely used IEEE 802.11 standard and in particular 802.11/b/g/n.

Wi-Fi router: The Device incorporates a router function that provides for routing of data packets from the Device to and from the one or more authorized audiovisual devices of the subscriber over the LAN and thus is able to transmit audiovisual content to multiple authorized audiovisual devices selectively and simultaneously. In the offline mode, the user of an authorized audiovisual device selects the Device as the wireless access point, i.e. the router, to receive audiovisual content from the Device. In the online mode, the user can select the Device or an external Wi-Fi device as the router to receive audiovisual content from the device. The Wi-Fi LAN where the Device acts as the router to transmit audiovisual content to one or more authorized external audiovisual devices is referred to herein as Internal Local Area Network or ILAN. The Wi-Fi LAN where an external Wi-Fi device acts as the router to transmit audiovisual content to one or more authorized external audiovisual devices is referred to herein as External Local Area Network or ELAN.

The Wi-Fi router of the Device maintains a configuration table that stores the physical (MAC) addresses of the authorized audiovisual devices operating over the ILAN. For each authorized device it assigns a local IP address. The Device local IP address is fixed, for example, as 192.168.1.1, while the local IP address assigned for the authorized audiovisual devices is variable, for example, as 192.168.1.n, where n is a variable. Local routing of audiovisual content from the Device to an authorized audiovisual device uses data packets that have the source and destination IP addresses defined as above.

In another embodiment of the invention, the connection to the internet is through an Ethernet connection. In an embodiment of the invention, the Ethernet port of the device is connected to an external router which is connected to an ISP gateway such as a cable modem or a DSL modem. In another embodiment, the Ethernet port of the device is connected directly to an ISP gateway such as a cable modem or a DSL modem. The Ethernet port is provided to allow connection to the internet using the ISP gateway at the maximum speed available and to reduce the time of audiovisual content download.

For the purpose of this invention, multimedia interface refers to a connection through which audiovisual contents are transmitted in the form of uncompressed audiovisual signal. An example of the multimedia interface is a High Definition Multimedia Interface (HDMI) connection. HDMI is a multimedia interface for transmitting uncompressed audiovisual signals from the Device to an audiovisual device. The Device can transmit the audiovisual contents in the form of uncompressed audiovisual signals through the media interface, for example, a HDMI connection, to a computer monitor, a video projector, or a TV. Further, the Device can support HDCP over its multimedia interface for digital content protection and use only by an authorized audiovisual device.

For the purpose of this invention, uncompressed audiovisual signal is digital video information in the form originally provided by the service provider for transmission over the internet before compression.

The device of the current invention can also have an audio port. The audio port is capable of transmitting audio content corresponding to the audiovisual content transmitted as uncompressed audiovisual signal through multimedia interface. This feature allows viewing of visual content of the audiovisual content on a video screen of an audiovisual device or on a visual device and listening to the audio content of the audiovisual content through an audio system. For example, the device is capable of transmitting visual contents to a TV through its multimedia interface connection and transmitting audio contents to a 5.1 speaker system through the audio port.

A visual screen refers to a device capable of displaying visual contents but not capable of audio output. Non-limiting examples of a visual device include a computer monitor which does not have built in speakers or a projector.

The audio system can be a surround sound system or a speaker system providing better audio output than the audiovisual device.

For the purpose of this invention, the term “portable device” indicates that the device can be easily carried by a user, i.e. the device is light-weight, small in size, and can be operated from internal battery, at least for a limited period of time, without requiring connection to an external power source, and includes a Wi-Fi interface to wirelessly connect to other devices over a LAN and to the internet through an external Wi-Fi router connected to an ISP gateway.

For the purpose of this invention the “online mode” indicates that the Device is connected to the internet; whereas, the offline mode indicates that the Device is not connected to the internet.

For the purpose of this invention, “stream,” or “streaming” as it applies to an authorized audiovisual device connected to the Device over a LAN refers to transmission of audiovisual content from the Device to the authorized audiovisual device over the LAN as data packets, wherein the audiovisual device stores the data packets received from the Device in a buffer memory while presenting the buffered data packets to audiovisual output of the audiovisual device.

For the purpose of this invention, “stream,” “streams,” “streams,” “streamed,” or “streaming” as it applies to the Device receiving audiovisual content over the internet from one or more service providers refers to receipt of audiovisual content by the Device in the form of data packets over the internet from the one or more service providers, buffering the data packets in the buffer memory of the Device. The Device can transmit the audiovisual contents to one or more authorized audiovisual devices over the LAN or as uncompressed audiovisual signal through a multimedia interface.

The Device can download the audiovisual content from the internet for storage in the internal memory at a scheduled time using the highest video encoded rate available from the service provider. As a non-limiting example, such download can be done at night when the device is not in active use by the subscriber.

The Device can also store an audiovisual content as the audiovisual content is streamed from the internet, i.e. the Device transmits the audiovisual content to the one or more authorized audiovisual devices and simultaneously stores the audiovisual content in the internal memory of the Device.

The Device can stream audiovisual content from one or more service providers over the internet and/or download audiovisual content for storage from one or more service providers. The audiovisual content streamed by the device or downloaded to the Device is accessible only to the architecture of the device, i.e. the Device allows access to the audiovisual content only to authorized audiovisual devices. This limited access to authorized audiovisual devices is managed by the DRM firmware.

For the purpose of this invention, audiovisual content stored in “a manner accessible only by the architecture of the device” indicates that the stored audiovisual content cannot be accessed and/or copied by an external device, i.e. is an unauthorized device which can be any electronic device, for example, a computer, that is capable of accessing, copying, and/or saving audiovisual content. The Device does not allow access, copying, and/or saving of audiovisual content by the external device. Non-limiting examples of external device include an unauthorized computer, an unauthorized mobile phone, and an unauthorized tablet.

When the Device transmits the audiovisual content to an authorized audiovisual device, the authorized audiovisual device cannot copy and/or save the audiovisual content.

For the purpose of this invention, a service provider provides audiovisual contents to a subscriber, optionally, for a payment. The service provider need to ensure that the content is transmitted only to authorized audiovisual devices and the content owner's rights are protected. They protect such rights by incorporating a process known as Digital Rights Management (DRM).

For the purpose of this invention Digital Rights Management (DRM) refers to the policy implemented by the service providers to ensure that the audiovisual content are only transmitted to authorized audiovisual devices so that the service provider's and content owner's rights are protected.

The service providers incorporate content access technology to enforce DRM. Content access technologies protect the content from access to unauthorized users by encrypting the content. In addition, they include a mechanism to enforce usage rules by granting licenses for the distributed audiovisual content. Such a license can support many types of business models including, but not limited to, subscription, purchase, pay per view, and rental. Additional business models where DRM can be applicable are well known to a person of ordinary skill in the art and such embodiments are within the purview of this invention.

An example of DRM technology used by many audiovisual content service providers is the PlayReady technology developed by Microsoft Corp. Microsoft Corp. published information about PlayReady technology in Microsoft's White Paper in July 2008, the content of which are herein incorporated by reference in their entirety. Additional examples of DRM technology are well known to a person of ordinary skill in the art and such embodiments are within the purview of this invention.

The Device supports implementation of DRM specific to one or more service providers through its programmable firmware. With DRM, the Device is able to transmit an audiovisual content streamed from a service provider or downloaded to the Device only to one or more authorized audiovisual devices. The Device does not grant access to the audiovisual contents to any external device, i.e. an unauthorized device, connected to the Device through the LAN. The Device stores the unique identifier of each authorized audiovisual device in its internal memory which can only be changed by going through an authorization process with one or more service providers which provided the Device. In addition, the audiovisual content transmitted to one or more authorized audiovisual devices in offline mode also complies with DRM policies thus maintaining the security of the audiovisual content. Each instance of transmission to any devices, including one or more authorized audiovisual devices and external devices, in the online and the offline mode can be logged by the Device and that information can be forwarded to the service provider for collection of statistics and/or for licensing purpose. Such information can also help the service provider to detect unauthorized transmission of the audiovisual content to external devices, for example, if the DRM firmware of the Device fails.

The Device can be remotely controlled by authorized audiovisual devices that have Wi-Fi capability. Non-limiting examples of such audiovisual devices include mobile phones, computers, and tablets. The one or more authorized audiovisual devices with Wi-Fi capabilities can control the Device through the Wi-Fi connection or through the wireless LAN connection. The operation of the Device by such a remote control device can include but is not limited to connecting the Device to a service provider, selection of the audiovisual content for streaming and selection of an audiovisual content for downloading and storing in the internal memory of the Device at a scheduled time, and for authorizing audiovisual devices. The application allowing such control can be provided by the service provider of the Device.

The Device can be powered by a battery. The battery can be a rechargeable battery or a non-rechargeable battery. The rechargeable battery is a type of electrical battery comprising of one or more electrochemical cells, and is a type of energy accumulator. Several different combinations of chemicals are commonly used, including: lead-acid, nickel cadmium (NiCd), nickel metal hydride (NiMH), lithium ion (Li-ion), and lithium ion polymer (Li-ion polymer).

Rechargeable batteries have lower total cost of use and environmental impact than disposable batteries. The type and capacity of battery chosen for Device is one that can provide about 5 hours to about 15 hours of continuous operation before requiring recharge by the external power source.

For longer periods the Device can be powered by an external power adapter, for example, through its USB port or through a power adapter.

The Device can transmit one or more audiovisual contents to one or more audiovisual devices in the online mode, the multichannel online mode, the offline mode, the multichannel offline mode, the hybrid mode, or the multichannel hybrid mode.

In an embodiment of the online mode, the Device and the authorized audiovisual devices connect to the internet using their Wi-Fi interfaces through an external Wi-Fi router or using their Ethernet ports through an external Ethernet router. The external routers assign local IP addresses to the Device and the authorized audiovisual devices forming a local area network referred to as XLAN among them. In this embodiment of the online mode, the Device transmits data packets to the authorized audiovisual devices through the XLAN. This embodiment of the online mode allows the authorized audiovisual devices to be connected to the internet and simultaneously receive audiovisual contents from the Device through the external router.

In another embodiment of the online mode, the authorized audiovisual devices are not connected to the internet directly; however, are connected to the Device using it as the wireless access point where the Device is connected through its Ethernet port to the external Ethernet router for connection to the internet. In this embodiment of the online mode, the Device streams one or more audiovisual contents from one or more service providers to the audiovisual devices authorized by the respective service providers. In this embodiment of the online mode, the Device transmits the audiovisual contents to the authorized audiovisual devices through the wireless local area network formed among the Device and the audiovisual devices referred to as the ILAN. In this embodiment of the online mode, the authorized audiovisual devices are not connected to the internet but only receive audiovisual contents streamed by the Device through ILAN.

In an embodiment of the offline mode, there is no external Wi-Fi router or external Ethernet router and no connection to the internet, the Internal Wi-Fi router in the Device serves as the wireless access point and assigns local IP addresses to the authorized audiovisual devices forming a Local Area Network (ILAN) among them. In the offline mode, the Device transmits audiovisual contents stored by the Device as data packets to the authorized audiovisual devices through the ILAN.

In another embodiment of the offline mode, there is no ISP gateway and hence no connection to the internet; however, the Device is connected to an external router and the authorized audiovisual devices are also connected to the external router. The Device transmits the audiovisual contents stored by the Device as data packets to the authorized audiovisual devices through the XLAN.

Thus, in both the online and the offline modes, the Device can be connected to one or more authorized audiovisual devices through the XLAN or the ILAN referred together as LAN.

In the online mode, the Device can stream one or more audiovisual contents from a service provider and transmit the one or more audiovisual contents to one or more authorized audiovisual devices. In the online mode, The DRM firmware ensures that an audiovisual content streamed from a service provider is only transmitted to one or more audiovisual devices authorized by the service provider. In one embodiment of the online mode, the Device transmits an audiovisual content streamed from a service provider to an authorized audiovisual device as uncompressed audiovisual signal through multimedia interface. In another embodiment of the online mode, the Device transmits an audiovisual content streamed from a service provider to an authorized audiovisual device as uncompressed audiovisual signal through the multimedia interface and simultaneously transmits the audiovisual content to one or more authorized audiovisual devices through the LAN. In a further embodiment of the online mode, the Device streams a first audiovisual from a service provider and transmits the first audiovisual content to a first authorized audiovisual device as uncompressed audiovisual signal through the multimedia interface, and simultaneously streams a second audiovisual from the service provider and transmits the second audiovisual content to certain one or more authorized audiovisual device through the LAN, and further simultaneously transmits a third audiovisual content streamed from the service provider to certain other one or more audiovisual devices through the LAN.

In the multichannel online mode, the Device can stream a plurality of audiovisual contents from a plurality of service providers and transmit the plurality of audiovisual contents to a plurality of authorized audiovisual devices authorized by their corresponding service providers. In the multichannel online mode, the DRM firmware ensures that an audiovisual content streamed from a particular service provider is only transmitted to one or more audiovisual devices authorized by that service provider. In an embodiment of a multichannel online mode, a first audiovisual device is authorized by a first service provider (but not a second service provider) and a second audiovisual device is authorized by the second service provider (but not the first service provider), the DRM firmware ensures that a first audiovisual content streamed from the first service provider is transmitted only to the first audiovisual device (and not the second audiovisual device) and a second audiovisual content streamed from the second service provider is transmitted only to the second audiovisual device (and not to the first audiovisual device).

In an embodiment of the multichannel online mode, the Device streams a first audiovisual content from a first service provider and transmits the first audiovisual content to a first audiovisual device authorized by the first service provider as uncompressed audiovisual signal through the multimedia interface, and simultaneously streams a second audiovisual content from a second service provider and transmits the second audiovisual content to certain one or more authorized audiovisual devices authorized by the second service provider through the LAN, and further simultaneously transmits a third audiovisual content streamed from a third service provider to certain other one or more authorized audiovisual devices authorized by the third service provider through the LAN. In an even further embodiment of the invention, the Device streams 2 to 10 audiovisual contents from 2 to 10 service providers and transmits the 2 to 10 audiovisual contents to a plurality of authorized audiovisual devices authorized by their respective service providers.

Additional combinations of transmission of a plurality of audiovisual contents streamed from a plurality of service providers to a plurality of authorized audiovisual devices through the LAN or the multimedia interface can be envisioned by a person of ordinary skill in the art and such combinations are within the purview of the current invention.

In the offline mode, the Device can download one or more audiovisual contents from a service provider and transmit the one or more audiovisual contents to one or more authorized audiovisual devices. The DRM firmware ensures that an audiovisual content downloaded from a service provider is only transmitted to one or more audiovisual devices authorized by the service provider. In one embodiment of the offline mode, the Device transmits an audiovisual content downloaded from a service provider to an authorized audiovisual device as uncompressed audiovisual signal through multimedia interface. In another embodiment of the offline mode, the Device transmits an audiovisual content downloaded from a service provider to an authorized audiovisual device as uncompressed audiovisual signal through the multimedia interface and simultaneously transmits the audiovisual content to one or more authorized audiovisual devices through the LAN. In a further embodiment of the offline mode, the Device downloads a first audiovisual content from a service provider and transmits the first audiovisual content to a first audiovisual device as uncompressed audiovisual signal through the multimedia interface, and simultaneously downloads a second audiovisual content from the service provider and transmits the second audiovisual content to certain one or more authorized audiovisual devices through the LAN, and further simultaneously transmits a third audiovisual content downloaded from the service provider to certain other one or more audiovisual devices through the LAN.

In the multichannel offline mode, the Device can download a plurality of audiovisual contents from a plurality of service providers and transmits the plurality of audiovisual contents to a plurality of authorized audiovisual devices. In the multichannel offline mode, the DRM firmware ensures that an audiovisual content downloaded from a particular service provider is only transmitted to one or more audiovisual devices authorized by that service provider. In an embodiment of a multichannel offline mode, a first audiovisual device is authorized by a first service provider (but not a second service provider) and a second audiovisual device is authorized by the second service provider (but not the first service provider), the DRM firmware ensures that a first audiovisual content downloaded from the first service provider is transmitted only to the first audiovisual device (and not the second audiovisual device) and a second audiovisual content downloaded from the second service provider is transmitted only to the second audiovisual device (and not to the first audiovisual device).

In an embodiment of the multichannel offline mode, the Device transmits a first audiovisual content downloaded from a first service provider to a first audiovisual device authorized by the first service provider as uncompressed audiovisual signal through the multimedia interface, and simultaneously transmits a second audiovisual content downloaded from a second service provider to certain one or more authorized audiovisual devices authorized by the second service provider through the LAN, and further simultaneously transmits a third audiovisual content downloaded from a third service provider to certain other one or more authorized audiovisual devices authorized by the third service provider through the LAN. In even further embodiment of the multichannel offline mode, the Device downloads 2 to 10 audiovisual contents from 2 to 10 service providers and simultaneously transmits the 2 to 10 audiovisual contents to a plurality of authorized audiovisual devices authorized by respective service providers.

Additional combinations of transmission of a plurality of audiovisual contents downloaded from a plurality of service providers to a plurality of authorized audiovisual devices through the LAN or the multimedia interface can be envisioned by a person of ordinary skill in the art and such combinations are within the purview of the current invention.

In the hybrid mode the Device is connected to the internet and transmits the audiovisual content streamed from a service provider to one or more authorized audiovisual devices and simultaneously transmits the audiovisual contents downloaded by the Device from the service provider to one or more authorized audiovisual devices through the LAN or as uncompressed audiovisual signal through the multimedia interface. The DRM firmware ensures that an audiovisual content downloaded to the Device or streamed from a particular service provider is only transmitted to one or more audiovisual devices authorized by that service provider.

In one embodiment of the hybrid mode, the Device transmits a first audiovisual content streamed from a service provider to an authorized audiovisual device as uncompressed audiovisual signal through the multimedia interface and simultaneously transmits a second audiovisual content downloaded by the Device from the service provider to one or more authorized audiovisual devices through the LAN. In another embodiment, the Device transmits a first audiovisual content streamed from a service provider to a first audiovisual device as uncompressed audiovisual signal through the multimedia interface and simultaneously transmits a second audiovisual content downloaded by the Device from the service provider to certain one or more authorized audiovisual devices through LAN, and further simultaneously transmits a third audiovisual content downloaded by the Device from the service provider to certain other one or more authorized audiovisual device through the LAN.

In the multichannel hybrid mode, the Device can stream a first plurality of audiovisual contents from a first plurality of service providers and transmits the first plurality of audiovisual contents to a first plurality of authorized audiovisual devices and simultaneously transmits a second plurality of audiovisual contents downloaded from a second plurality of service providers to a second plurality of authorized audiovisual devices. In the multichannel hybrid mode, the DRM firmware ensures that an audiovisual content downloaded from a particular service provider or streamed from the service provider is only transmitted to one or more audiovisual devices authorized by that service provider. In an embodiment of a multichannel hybrid mode, a first audiovisual device is authorized by a first service provider (but not a second service provider) and a second audiovisual device is authorized by the second service provider (but not the first service provider), the DRM firmware ensures that a first audiovisual content downloaded from the first service provider is transmitted only to the first audiovisual device (and not the second audiovisual device) and a second audiovisual content streamed from the second service provider is transmitted only to the second audiovisual device (and not to the first audiovisual device).

In an embodiment of the multichannel hybrid mode, the Device downloads a first audiovisual content from a first service provider and transmits the first audiovisual content to a first audiovisual device authorized by the first service provider as uncompressed audiovisual signal through the multimedia interface, and simultaneously streams a second audiovisual content from a second service provider and transmits the second audiovisual content to certain one or more authorized audiovisual devices authorized by the second service provider through the LAN, and further simultaneously transmits a third audiovisual content streamed from a third service provider to certain other one or more authorized audiovisual devices authorized by the third service provider through the LAN. In even further embodiment of the multichannel hybrid mode, the Device downloads 2 to 10 audiovisual contents from 2 to 10 service providers, simultaneously streams 2 to 10 audiovisual contents from 2 to 10 service providers and transmits the 4 to 20 audiovisual contents to a plurality of authorized audiovisual devices authorized by their respective service providers.

Additional combinations of transmission of a plurality of audiovisual contents downloaded from a plurality of service providers or streamed from a plurality of service providers to a plurality of authorized audiovisual devices through the LAN or the multimedia interface can be envisioned by a person of ordinary skill in the art and such combinations are within the purview of the current invention.

In the online, the offline, or the hybrid mode, the Device can allow each member of a group, for example, several members of a family, to view their own selected content on their personal audiovisual devices simultaneously, for example, a TV, a computer, or a mobile phone. Through these different modes the Device can also allow each member of a group, for example, several members of a family, to view their own selected content downloaded or streamed from their own preferred service provider on their personal audiovisual device. The simultaneously transmission of a plurality of downloaded audiovisual contents to a plurality of audiovisual devices offer major benefits and convenience to subscribers, especially when the subscribers are outdoors, in a hotel, on a cruise, or anywhere in instances when going online is not possible or cost effective.

The number of audiovisual contents that can be simultaneously streamed by the Device over the internet depends upon the available internet bandwidth and the quality of the content. For example, a high definition (HD) content generally requires a bandwidth of 5 Mbits/sec (Mb/s) or more while a lower quality such as standard definition (SD) content can work at a lower bandwidth of about 2 Mb/s. On the other hand, 3D HD content may require a much higher bandwidth, for example, over about 9 Mb/s. When downloading an audiovisual content for storage at a scheduled time it is possible to receive the highest possible quality of the audiovisual content provided by a service provider even with a lower bandwidth internet connection at the tradeoff of the time it takes to download such the audiovisual content.

The number of audiovisual devices that can simultaneously receive audiovisual contents from the Device over the LAN depends on the bandwidth of the LAN. Typically, every two Mb/s of the LAN bandwidth would allow the Device to transmit an SD quality audiovisual content to one audiovisual device, i.e. the number of audiovisual devices that can simultaneously receive SD quality audiovisual contents from the Device is equal to the LAN bandwidth (in Mb/s) divided by two. For example, LAN bandwidth of fifty Mb/s would allow the Device to transmit one or more SD quality audiovisual contents to about twenty-five audiovisual devices.

Also, every five Mb/s of the LAN bandwidth would allow the Device to transmit an HD quality audiovisual content to one audiovisual device, i.e. the number of audiovisual devices that can simultaneously receive HD quality audiovisual contents from the Device is equal to the LAN bandwidth (in Mb/s) divided by five. For example, LAN bandwidth of hundred Mb/s would allow the Device to transmit one or more HD quality audiovisual contents to about twenty audiovisual devices.

Further, every fifteen Mb/s of the LAN bandwidth would allow the Device to transmit a Blu-Ray™ quality audiovisual content to one audiovisual device, i.e. the number of audiovisual devices that can simultaneously receive Blu-Ray™ quality audiovisual contents from the Device is equal to the LAN bandwidth (in Mb/s) divided by fifteen. For example, LAN bandwidth of fifty Mb/s would allow the Device to transmit one or more one or more Blu-Ray™ quality audiovisual contents to about three audiovisual devices.

Table below illustrates some examples of the tradeoffs affecting internet bandwidth, quality of audiovisual contents and download time.

| | Internet | | |
|---|---|---|---|
| | Available | | |
| | Bandwidth | | Download |
| | (Mb/s) | Device Usage | time (Hrs) |
| 1 | 1.0-2.0 | Download HD quality DVD audiovisual | 1-2 |
| | | content for offline viewing | |
| 2 | 2.0-5.0 | Stream 1 SD quality audiovisual content | |
| 3 | 2.0-5.0 | Download HD quality DVD audiovisual | 0.25-1.0 |
| | | content for offline viewing | |
| 4 | 5.0-10.0 | Stream 1-2 HD quality audiovisual contents | |
| 5 | 5.0-10.0 | Download Blu-ray ™ quality DVD audio- | 0.25-1.0 |
| | | visual content for offline viewing | |
| 6 | 10.0-20.0 | Stream 2 HD quality audiovisual contents | |
| 7 | 10.0-20.0 | Stream 3D HD quality audiovisual contents | |
| 7 | 20.0-30.0 | Stream 3 HD quality audiovisual contents | |
| 8 | 30.0-50.0 | Stream 3-5 HD quality audiovisual contents | |
| 9 | 30.0-50.0 | Download 2-3 Blu-ray ™ DVD quality | 1.0-2.0 |
| | | audiovisual contents for offline viewing | |

As opposed to physical media by mail the wait time is practically eliminated with the use of the Device. Disposing of the audiovisual content is even easier and faster since the device is able to erase the audiovisual content with no need for return. Device can then start download of new audiovisual content in the freed storage space. The Device can have sufficient data storage capacity to save a number of movies, for example, 2 to 10 movies. The number of movies that can be stored on the Device can be based on the type of subscription the subscriber has with the service provider. For example, with a subscription to one movie at a time plan, a subscriber will be able to watch a new movie every day. With a subscription allowing for multiple movies at a time, a subscriber can watch multiple movies every day. This is a substantial advantage over physical media by mail plan, where a subscriber with one or two DVD at a time can receive only one or two physical media every week.

Following are examples that illustrate procedures for practicing the invention. These examples should not be construed as limiting.

### Example 1

### An Exemplified Architecture of the Device

Device Architecture:

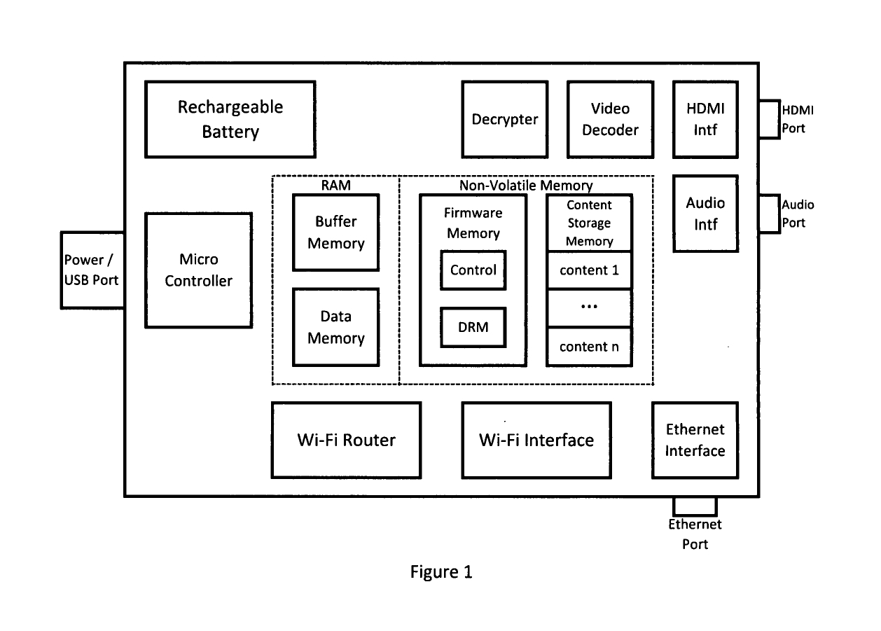

FIG. 1 shows the architecture of the Device. The major functional blocks of the Device are a microcontroller with firmware, a buffer memory for temporarily storing of content while streaming from the internet, a non-volatile memory of sufficient capacity for storage of the audiovisual content, DRM firmware implementing service provider specific DRM policies and business models, Decrypter for restoring the encrypted audiovisual content to the original compressed audiovisual content, Video decoder for converting the compressed audiovisual content to uncompressed audiovisual signal, HDMI interface, an Ethernet port and a Wi-Fi interface for connecting to internet through an external Wi-Fi router, and for local wireless communication to one or more audiovisual devices in the offline mode, a Wi-Fi router to selectively transmit data packets to authorized audiovisual devices over the ILAN, a Bluetooth interface, a USB/Power port for connection to a computer or a power adapter and a rechargeable battery for operation without external power source. To ensure that the audiovisual content is not accessible to unauthorized external devices, the Device keeps a list of the unique identifiers of each of the authorized audiovisual devices in its internal non-volatile memory. A brief description of the major functional blocks is provided below:

Microcontroller with Firmware:

Commonly referred to as a μC or MCU, the Microcontroller is a single integrated circuit designed for embedded applications providing real time execution of system tasks. The microcontroller contains a processor core, data memory and programmable inputs and outputs. The operation of the microcontroller is controlled by a program stored either in an on chip memory or in an external memory device. The program is called firmware. Many types of microcontroller devices are available from different manufacturers. Some examples are devices from many vendors using ARM core processors, devices from manufacturers such as Atmel, Freescale, Intel, Marvel, Qualcomm, Texas Instruments etc.

Buffer Memory:

For online real-time streaming the Device uses a buffer memory to temporarily store streamed content so that the output to the audiovisual device is as continuous and without interruption as possible. Generally, the buffer memory size is determined based on 5 to 15 seconds of viewing time of the audiovisual program. For example, for streaming one HD quality audiovisual content at 5 Mb/s would require about 10 MB of buffer memory. Also, for streaming 4 HD quality audiovisual contents at 5 Mb/s would require about 50 MB of buffer memory. The Device can have about 128 MB to about 1 GB of buffer memory.

Storage Memory:

For storing media content, non-volatile random access memory (NVRAM) is used. The size of the memory depends upon the amount of content that is desired to be stored. The highest quality encoded streaming video could require a few GB of storage for a typical movie. To support one HD movie content, a capacity of 4 GB will be necessary, a capacity of 32 GB will be adequate for storing multiple HD quality movies. To store a highest quality Blu-ray DVD content, a capacity of 8 to 12 GB may be necessary. With the availability of low cost of memory, it is feasible to provide higher capacity supporting storage of several HD quality and Blu-ray DVD quality movies The actual size selected in a given implementation will depend upon the maximum quality of video content provided by the service provider for storage and the maximum amount of audiovisual content available for rental from the service provider.

Firmware Memory:

The operation of the microcontroller is controlled by a program stored either in an on chip memory or in an external memory device. The program is called firmware. Program memory is field-alterable flash or erasable read only memory supporting easy updates of the firmware in the field. The firmware consists of control firmware to control the various tasks to be performed in the operation of the Device. It also contains specific firmware such as DRM specific to a service provider.

DRM: Firmware implementing service provider specific DRM policies and business models as described before.

Decrypter: This is a combination of firmware and digital logic to implement service provider specific algorithms to de-encrypt streamed video.

Video Decoder: Streaming video is highly compressed to reduce transmission bandwidth required. The video compression algorithm achieves very high rates of compression by exploiting the redundancy in video information. Currently H.264/MPEG-4 AVC is the most commonly used format for recording, compression and distribution of high definition video by internet streaming services. The Video decoder converts the compressed video to its uncompressed form for display on TV. Low cost single chip devices capable of decoding H.264/MPEG-4 AVC compressed video are available from several manufacturers.

Bluetooth interface: A Bluetooth interface is provided to allow an authorized portable audiovisual device to do an initial configuration set up and optionally also serve as a remote control device.

USB/Power port: A USB port with at least the widely used standard 2.0 and preferably the latest standard 3.0 is provided to allow interfacing the Device to a portable computer. The same port is used to connect to an external power adapter for charging the internal rechargeable battery and for Device operation over extended periods of time.

### Example 2

### Initial Setup and Configuration Procedure

After a subscriber purchases the Device the subscriber needs to perform the initial set up and configuration procedure before the Device can be used. When the Device is first powered up, however, it cannot connect to the internet automatically using Wi-Fi without additional configuration unless it is connected through its Ethernet port to an external Ethernet router connected to the internet. It also needs to register the audiovisual devices the subscriber will be connecting with the Device. The following procedure illustrates the steps necessary to complete the initial setup and configuration.

1) Connect an audiovisual device to the service provider over the internet and download the application (the App) specific to the service provider. The App is to control the operation of the Device when streaming or downloading audiovisual content from that service provider.

2) Connect the Device to a TV through the HDMI interface. Power-up the Device. Disconnect the audiovisual device having the App installed thereon from the external Wi-Fi router and select the Device as its wireless access point, i.e. the audiovisual device with the App installed thereon connects to the Device through the Device's ILAN by entering the SSID (Network ID) and password of the Device provided by the service provider, for example, printed on the label of the Device.

3) Run the App on the audiovisual device. The App can have a setup mode. In the setup mode, the App transmits the physical address (MAC address) of the audiovisual device to the Device. The Device stores the MAC address of the audiovisual device in its internal nonvolatile memory.

4) The App will next prompt for the SSID and password for of the external wireless router for allowing the Device to make a connection to the external Wi-Fi router, If the Device is to be connected to the internet using Wi-Fi.

Once this information is provided, the Device is able to make connection to the internet. The initial configuration of the Device and the registration of the first audiovisual device is complete.

5) The Device is then restarted and the Device automatically connects to the internet based on the information provided by the authorized audiovisual device in step 4 above. The Device is now waiting for commands from the audiovisual device. The audiovisual device can then direct the Device to connect to the service provider.

6) The remaining audiovisual devices can be registered similarly after first running the App on the respective devices.

In another embodiment of the Device, the Device could incorporate wireless transmission technologies such as Infra-Red (IR) or Radio Frequencies (RF) to allow conventional remote control devices to be used for the initial set up and configuration procedure as outlined in above steps.

We claim:

1. A device comprising:
a. a connection to the internet,
b. a storage memory for storing one or more audiovisual contents downloaded from one or more service providers, wherein the one or more audiovisual contents are stored in a manner accessible only by the architecture of the device and wherein the device transmits the stored one or more audiovisual contents only to one or more audiovisual devices authorized by the one or more service providers,
c. one or more connections for transmitting the one or more audiovisual contents to the one or more authorized audiovisual devices,
wherein, the device is capable of downloading the one or more audiovisual contents and when the device is not connected to the internet, transmitting over an internal local area network (ILAN) where the device acts as the router, the one or more audiovisual contents as data packets to the one or more audiovisual devices authorized by the one or more service providers.

2. The device of claim 1, wherein a Digital Rights Management (DRM) firmware specific for the one or more service providers manages the transmission of the one or more audio visual contents to the one or more audiovisual devices authorized by the one or more service providers; wherein the device stores a unique identifier of each authorized audiovisual device as provided by the one or more service providers.

3. The device of claim 2, wherein the unique identifier is the audiovisual device's media access control (MAC) address.

4. The device of claim 1, wherein the device is capable of simultaneously transmitting the one or more audiovisual contents downloaded from the one or more service providers to two or more audiovisual devices authorized by the one or more service providers.

5. The device of claim 1, wherein the device is capable of simultaneously transmitting two or more audiovisual contents downloaded from the one or more service providers to two or more audiovisual devices authorized by the one or more service providers.

6. The device of claim 1, wherein the connection to the one or more authorized audiovisual devices is a wireless connection or a physical connection.

7. The device of claim 1, wherein the device is capable of being operated remotely by an authorized audiovisual device through ILAN, wherein the ILAN comprises Ethernet ILAN or wireless ILAN.

8. A device comprising:
a. a connection to the internet,
b. two or more connections for streaming two or more audiovisual contents received from one or more service providers to the two or more audiovisual devices authorized by the one or more service providers, and
wherein, the device is capable of streaming, over an external local area network (XLAN) through an external router or over an internal local area network (ILAN) where the device acts as the router, the two or more audiovisual contents as data packets or as uncompressed audiovisual signal over a multimedia interface to the two or more audiovisual devices authorized by the one or more service providers.

9. The device of claim 8, wherein a DRM firmware specific for the one or more service providers manages the streaming or transmission of the two or more audio visual contents to the two or more audiovisual devices authorized by the one or more service providers; wherein the device stores the unique identifier of each authorized audiovisual device as provided by the one or more service providers.

10. The device of claim 9, wherein the unique identifier is the audiovisual device's MAC address.

11. The device of claim 8, wherein the connection to the one or more authorized audiovisual devices is a wireless connection through XLAN or ILAN or a physical connection through XLAN or ILAN.

12. The device of claim 8, wherein the device is capable of being operated remotely by an authorized audiovisual device through the XLAN or the ILAN.

13. A device comprising:
a. a connection to the internet,
b. a storage memory for storing a first one or more audiovisual contents downloaded from a first one or more service providers, wherein the first one or more audiovisual contents are stored in a manner accessible only by the architecture of the device and wherein the device transmits the first one or more stored audiovisual contents only to a first one or more audiovisual devices authorized by the first one or more service providers,
c. a first one or more connections for transmitting the first one or more audiovisual contents to the first one or more audiovisual devices authorized by the first one or more service providers, and
d. a second one or more connections for streaming a second one or more audiovisual contents received from a second one or more service providers to a second other one or more audiovisual devices authorized by the second one or more service providers,
wherein, the device is capable of:
transmitting, over an internal local area network (ILAN) where the device acts as a router or over an external local area network (XLAN) through an external router, the first one or more stored audiovisual contents to the first one or more audiovisual devices authorized by the first one or more service providers as data packets or as uncompressed audiovisual signal over a multimedia interface,
and simultaneously
streaming, over the XLAN through the external router or over the ILAN where the device acts as the router, the second one or more audiovisual contents received from the second one or more service providers to the second one or more audiovisual devices authorized by the second one or more service providers as data packets or as uncompressed audiovisual signal over a multimedia interface.

14. The device of claim 13, wherein a first DRM firmware specific for the first one or more service providers manages the transmission of the first one or more stored audio visual contents to the first one or more audiovisual devices authorized by the first one or more service providers and a second DRM firmware specific for the second one or more service providers manages the streaming of the second one or more audio visual contents to the second one or more audiovisual devices authorized by the second one or more service providers; wherein the device stores the unique identifier of each authorized audiovisual device as provided by the one or more service providers.

15. The device of claim 14, wherein the unique identifier is the audiovisual device's MAC address.

16. The device of claim 13, wherein the device is capable of transmitting the first two or more audiovisual contents to the first two or more audiovisual devices authorized by the first one or more service providers and streaming the second two or more audiovisual contents to the second two or more audiovisual devices authorized by the second two or more service providers.

17. The device of claim 13, wherein the connection to the one or more authorized audiovisual devices is a wireless connection over the XLAN or the ILAN or a physical connection over the XLAN or the ILAN.

18. The device of claim 13, wherein the device is capable of being operated remotely by an authorized audiovisual device through the XLAN or the ILAN.
